(19) United States
(12) Patent Application Publication
(10) Pub. No.: US 2004/0171350 A1
(43) Pub. Date: Sep. 2, 2004

(54) Data management method for running an interactive software

(76) Inventors: Minh Le, Paris (FR); Gilles Ambone, Courbevoie (FR)

Correspondence Address: Sughrue Mion, Suite 800, 2100 Pennsylvania Avenue NW, Washington, DC, 20037-3213, US

(21) Appl. No.: 10/480,833

(22) PCT Filed: Apr. 22, 2003
(86) PCT No.: PCT/FR03/01268

(30) Foreign Application Priority Data
Apr. 24, 2002 (FR) 02/05122

(51) Int. Cl. H04Q 7/20

(52) U.S. Cl. 455/67.13

(57) ABSTRACT

The present invention relates to a method of managing data between at least two electronic communication stations (C, O) whose users, referred to as challenger and opponent, cooperate interactively to execute software to be instantiated, referred to as an interactive program, which method is characterized in that the two stations are equipped with said software, the challenger sends a first electronic message (P) containing at least a first portion of the instantiated software and the opponent sends a second electronic message (Re, Ri) linked to the first and containing a second portion of the instantiated software, the software then running on each station (C, O).

The present invention relates to a method of managing data for executing interactive software.

To be more precise, it relates to a method of managing data between at least two electronic communication stations whose users, referred to as challenger and opponent, co-operate interactively to execute software.

A particular application of the method is to executing interactive game software whose players, challenger and opponents, can communicate electronically via the mobile telephone network using Short Message Service (SMS) messages or via the mobile telephone network and the Internet using electronic mail, Multimedia Message Service (MMS) or Enhanced Message Service (EMS) messages.

A data management method of the above type is described in the patent document WO 01/67275.

According to that document, a server equipped with the software of the game is systematically used to manage all data transmitted between players, challenger and opponents. The data is communicated via the mobile telephone network and the Internet by means of SMS or electronic mail messages.

Challenges are managed in the following manner: The challenger sends his challenge to the server from a first station. The challenge can be sent to an opponent who, if he accepts it, sends an acceptance message to the server. The software can then be run in the server, which then sends the result of the game to the two players.

This kind of management necessitates the exchange of at least five electronic messages between the players and the server, and communication sessions are initiated either by one of the stations or by the server. This complicates billing in the case of sessions opened by the server, in which case the players are clients.

Moreover, the above kind of method systematically necessitates a server of relatively great complexity.

The invention solves the above problems and to this end proposes a method of managing data between at least two electronic communication stations whose users, referred to as challenger and opponent, cooperate interactively to execute software to be instantiated, referred to as interactive software, which method is characterized in that the two stations are equipped with said software, the challenger sends a first electronic message containing at least a first portion of the instantiated software and the opponent sends a second electronic message linked to the first and containing a second portion of the instantiated software, the software then running on each station.

In a first preferred embodiment, the first and second messages are sent directly to the other station.

In this embodiment, the challenger knows the opponent and transmits his challenge directly to him.

In this case, the first message advantageously contains a proposal by the challenger to run the software and the second message contains a response of the opponent and is linked to said first message.

The two stations then have all the information for running the software, which can be run on each station.

Said communication stations are preferably mobile telephones and said messages are SMS messages.

In a second preferred embodiment, the first and second messages are sent to a server.

In this embodiment, the challenger submits to the server a challenge that is open to any opponent. Responses from a plurality of opponents can also be processed in this way.

In this case, the first message advantageously contains a proposal by the challenger to run the software and the second message contains the response of the opponent, the server sending said proposal to the opponent in the same communication session as the second message.

The server can send a URL address to the challenger in the same communication session as the first message, the challenger going to said address to obtain said response, or the server sends a URL address to the challenger after receiving the second message, the challenger going to said address to obtain said response.

Said communication stations are preferably mobile telephones.

The invention also provides a mobile telephone including electronic communication means for implementing the method according to any one of the preceding claims, the mobile telephone being characterized in that it is equipped with interactive software and includes means for instantiating and programming software portions and means for sending and receiving software portions via said communication means.

The invention is described in more detail hereinafter with the aid of figures showing a preferred embodiment of the invention.

FIG. 1 is a diagrammatic view representing a first variant of the method according to the invention.

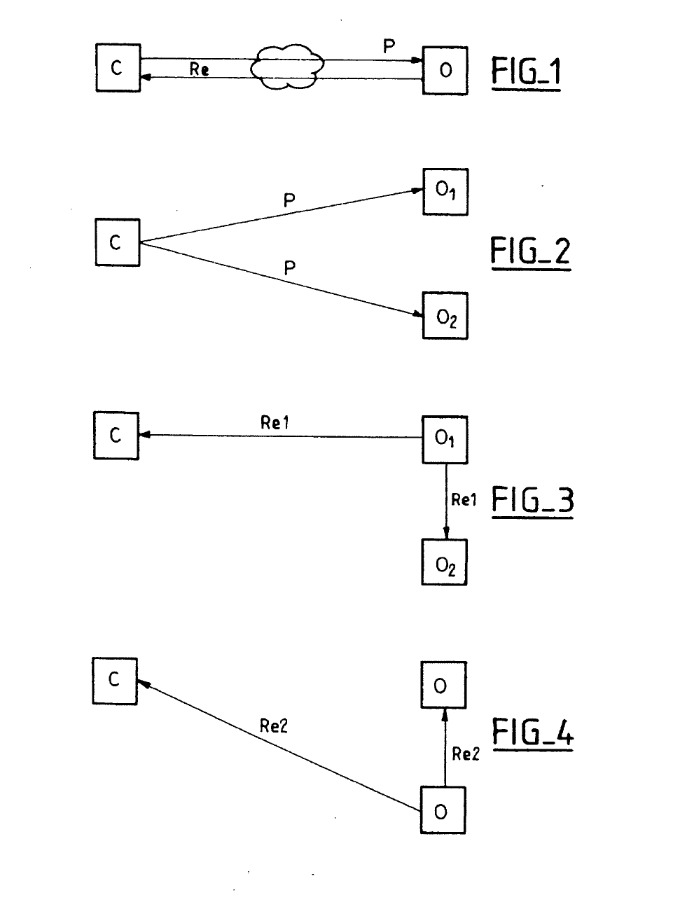

FIGS. 2 to 4 are diagrammatic views representing a multiplayer mode of the first variant of the method according to the invention.

FIGS. 5 to 7 are diagrammatic views representing a second variant of the method according to the invention.

As shown in FIG. 1, two electronic communication stations C and O, which can be mobile telephones or computers, can communicate via the mobile telephone network and/or the Internet using SMS, MMS, EMS or electronic mail messages.

The user of the station C is the challenger and the user of the station O is an opponent, and the respective data processing systems of the two stations are equipped with interactive software, preferably constituting a computer game.

The game can be a robot wars simulation, for example. At the start of the game, the challenger creates a robot by programming its characteristics. For example, each robot is defined by three characteristics, “weapon”, “armor” and “memory”. “Weapon” symbolizes the offensive power of the robot, “armor” its defensive capability and “memory” its capacity to be programmed. Each memory module provides one instruction code. Examples of instructions are: advance, fire, pause, etc. These instructions determine the behavior of the robot. The robot combats take place in an arena that can be chosen from a series of different arenas.

In a first variant, there is no associated server.

The challenger knows his opponent and sends him a challenge via his station C by means of an SMS, MMS, EMS or email message constituting a first message P. This first message P contains his proposal to run the software, in other words, in the example of the game described above, his programmed robot and the associated arena. If the opponent accepts this challenge, he sends the station C via his station O a second message containing his response Re to the proposal, in other words his own programmed robot and a link to the first message. The two stations then have all the data required to run the software locally.

This first variant applies equally to multiplayer games, in which a plurality of players participate simultaneously in the same arena.

A multiplayer game of this kind is shown diagrammatically in FIGS. 2 to 4.

As shown diagrammatically in FIG. 2, the challenger knows two opponents and sends each of them a challenge by means of an SMS, MMS, EMS or electronic mail message constituting a first message P. This first message P contains his proposal to run the software, in other words, in the example of the game described above, his programmed robot and the associated arena. The message P also contains a list of players in the case of an SMS message. In the case of an MMS or electronic mail message, the distribution list is systematically included in the message.

If the first opponent accepts the challenge, as shown in FIG. 3, he sends a message containing his response Re1 to the proposal, in other words his own programmed robot and a connection to the first message, via his station I1 to the station C of the challenger and to the station O2 of the other opponent from the circulation list.

Similarly, if the second opponent accepts the challenge, as shown in FIG. 4, he sends a second message containing his response Re2 to the proposal, in other words his own programmed robot and a link to the first message, via his station O2 to the station C of the challenger and to the station O1 of the other opponent from the circulation list.

All the stations C, O1 and O2 then have all the data required to run the software locally, the three robots and the arena being stored in the three stations.

The number of messages initiated per player is therefore one less than the number of players, in other words one message in the case of two players, as shown diagrammatically in FIG. 1, and two messages in the case of three players, as shown diagrammatically in FIGS. 2 to 4.

FIG. 5 represents diagrammatically a second variant of the invention.

In this variant the stations communicate on the mobile telephone network via a server S and by means of SMS or electronic mail messages, for example using the Wireless Application Protocol (WAP) and Internet Protocol. In fact, at present, this kind of call from a mobile telephone uses the Wireless Application Protocol in the mobile telephone network as far as a gateway at which the format is converted to one compatible with the Internet, and then travels via the Internet to the server (and vice-versa).

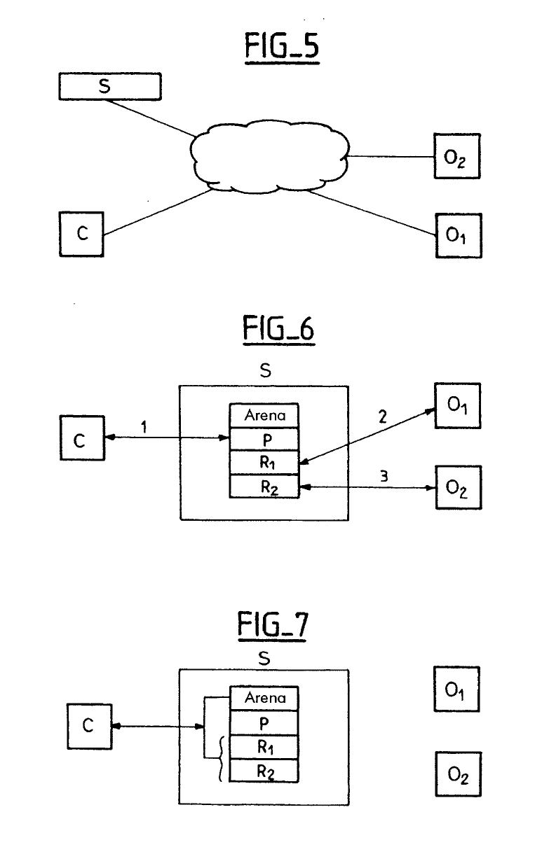

FIGS. 6 and 7 represent diagrammatically the exchange of messages.

A first message 1 is sent by the challenger using a game menu and the Wireless Application Protocol. This is his challenge, in other words, in the example of the game described above, his programmed robot with an associated arena chosen by visiting the game's website. In exchange, during the same communication session, the server sends the station C a Uniform Resource Locator (URL) designating that “arena,robot” resource in the server as well as a stamp defined by the chosen arena. In the present context a stamp is time information associated with an event and defines the time period during which the challenger cannot modify the proposal P.

Using the game menu, an opponent sends a second message 2, 3 via his station Oi. This message contains his response Ri, in other words, in the example of the game described above, the robot programmed for fighting by the opponent after consulting the game's website. The server S stores the robot Ri linked to the arena and to the proposed robot P and in exchange sends the data for the arena and the proposed robot P to the station Oi.

The game software can then run locally on the station Oi.

If the challenger wishes to play, within the time period defined by the stamp, he visits the URL previously transmitted and stores all the responses or robots Ri that have opted to fight his robot in the arena in question. The game software can then run locally on the station C.

Alternatively, the URL may not be sent to the challenger in the same communication session as the first message, as previously described, but instead transmitted to him after reception by the server S of the second message Ri, at the same time indicating to him that the responses or robots Ri are available.

The duration of the stamp is preferably 48 hours, and to allow for the message transmission time the proposal or proposed robot disappears from the station Oi of the opponent approximately 4 hours before the end of the 48 hour period.

This second variant applies equally to a multiplayer game, a plurality of players participating simultaneously in the same arena.

In this case, the arena can be defined by a maximum number of players or by an elapsed time.

As shown diagrammatically in FIG. 6, a first message 1 is sent by the challenger using a game menu and the Wireless Application Protocol. This is his challenge, in other words, in the example of the game described above, his programmed robot with an associated arena chosen by visiting the game's website. In response, and in the same communication session, the server sends the station C a URL designating this “robot” resource in the server and a stamp defined by the chosen arena.

An opponent sends a message 2 from his station O1 using the game menu and the Wireless Application Protocol. This is the response R1, in other words, in the example of the game described above, the robot programmed for fighting by the opponent after visiting the game's website. The server S stores the robot R1, linked to the arena and to the proposed robot P, and in response sends the station O1 a URL designating this “robot” resource in the server and the stamp.

When the arena is defined by an elapsed time, the opponent sends a message 3 from his station O2 using the game menu and the Wireless Application Protocol. This is the response R2, in other words, in the example of the game described above, the robot programmed for fighting by the opponent after visiting the game's website. The server S stores the robot R2, linked to the arena and to the proposed robot P, and in response sends the station O2 a URL designating this “robot” resource in the server and the stamp.

At the end of the elapsed time, all of the data linked to the arena is transmitted to each player using the URLs, and all the stations C, O1 and O2 then have all the data required to tun the software locally, the three robots and the arena being stored in the three stations.

If the arena is defined by a maximum number of players, for example three players, the last opponent sends a message 3 from his station O2 using the game menu and the Wireless Application Protocol. This is the response R3, in other words, in the example of the game described above, the robot programmed for fighting by the opponent after visiting the game's website. The server S stores the robot R3, linked to the arena and to the proposed robot P, and in response sends the station O3 all the data already linked to the arena, i.e. the robots of the other players.

The game software can then run locally on the station O3.

If the challenger and the first opponent wish to play within the time period defined by the stamp, they visit the corresponding URL previously transmitted and download all the responses or robots Ri that have opted to fight in the arena in question. The game software can then run locally on the stations C and O1.

Thanks to the invention, interactive data management is achieved by means of a single session opened directly by a server, the other sessions being initiated by the players or clients, which limits the necessity for indirect billing.

Although the multiplayer modes described above are limited to three players, they can of course be extended to n players in a manner that will be evident to the person skilled in the art, using the same transmission rules.

1. A method of managing data between at least two electronic communication stations (C, O) whose users, referred to as challenger and opponent, cooperate interactively to execute software to be instantiated, referred to as an interactive program, which method is characterized in that the two stations are equipped with said software, the challenger sends a first electronic message (P) containing at least a first portion of the instantiated software and the opponent sends a second electronic message (Re, R1) linked to the first and containing a second portion of the instantiated software, the software then running on each station (C, O).

2. A management method according to claim 1, characterized in that the first and second messages (P, Re) are sent directly to the other station.

3. A management method according to claim 2, characterized in that the first message (P) contains a proposal by the challenger to run the software and the second message (Re) contains a response of the opponent and is linked to said first message.

4. A management method according to any one of the preceding claims, characterized in that said communication stations are mobile telephones and said messages are SMS messages.

5. A management method according to claim 1, characterized in that the first and second messages (P, Ri) are sent to a server (S).

6. A management method according to claim 5, characterized in that the first message (P) contains a proposal by the challenger to run the software and the second message (Re) contains the response of the opponent, the server (S) sending said proposal (P) to the opponent in the same communication session as the second message (Re).

7. A management method according to claim 6, characterized in that the server (S) sends a URL address to the challenger in the same communication session as the first message (P), the challenger going to said address to obtain said response.

8. A management method according to claim 6, characterized in that the server (S) sends a URL address to the challenger after receiving the second message (Ri), the challenger going to said address to obtain said response.

9. A management method according to any one of claims 5 to 8, characterized in that said communication stations are mobile telephones.

10. A mobile telephone including electronic communication means for implementing the method according to any one of the preceding claims, the mobile telephone being characterized in that it is equipped with interactive software and includes means for instantiating and programming software portions and means for sending and receiving software portions via said communication means.
